(19) United States
(12) Patent Application Publication
(10) Pub. No.: US 2002/0122550 A1
(43) Pub. Date: Sep. 5, 2002

(54) Automatic telephone dialer

(76) Inventor: Norman F. Noplock, Baltimore, MD (US)

Correspondence Address: Michael S. Neustel, Suite No. 4, 2534 South University Drive, Fargo, ND, 58103, US

(21) Appl. No.: 10/026,513

(22) Filed: Dec. 20, 2001

Related U.S. Application Data
(60) Provisional application No. 60/258,362, filed on Dec. 27, 2000.

(51) Int. Cl. H04M 1/00; H04M 3/00

(52) U.S. Cl. 379/355.01

(57) ABSTRACT

The inventive apparatus, hereto called an Automatic Telephone Dialer (ATD), is a telephone device that implements the inventive method. The ATD is designed to automatically and directly connect long distance phone calls to predefined long distance service providers' telephone switching equipment by means of automatically dialing the providers' long distance dial around prefix numbers, to provide protection to the consumer against unauthorized switching of the long distance service provider known as “slamming,” and to allow for the user to conveniently program and store a personal prefix, such as a three digit area code, that could be appended to the normal seven digits dialed in order to complete a local phone call. The ATD captures digits dialed by the telephone by monitoring the activity on the telephone line. As the digits are detected the device determines what intervention is required, if any. When intervention is required, the ATD initiates a new call, adding the appropriate dialing prefixes as required. The re-dialing process occurs with a minimum amount of delay and is completely transparent to the user. The ATD is a small and unobtrusive telephone appliance installed between the telephone and the telephone wall jack and is compatible with the standard household and business touch-tone telephone.

### CROSS REFERENCE TO RELATED APPLICATIONS

I hereby claim benefit under Title 35, United States Code, and Section 119(e) of U.S. provisional patent application Serial No. 60/258,362 filed Dec. 27, 2000. This application is a continuation of the U.S. Pat. No. 60/258,362 application. The U.S. Pat. No. 60/258,362 application is currently pending. The U.S. Pat. No. 60/258,362 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to standard telephone appliances and more specifically it relates to a method and apparatus for an automatic telephone dialer to determine to append the dialed number with additional numbers to effect connection.

2. Description of the Prior Art

It can be appreciated that standard telephone appliances have been in use for years. Typically, standard telephone appliances are comprised of telephone line automatic dialers, automatic speed dialers and auto dialers embedded as a feature in a multi-purpose telephone device.

Unfortunately, prior art designs of standard telephone devices do not include a method or apparatus that automatically and directly connects long distance calls, from the user's dial point, to long distance providers' telephone switching equipment. Nor does prior art include or implement a method or apparatus that leverages the use of the telecommunications industry established long distance providers' Primary intraLata Carrier (PIC) code known throughout this document as a “dial around prefix (DAP).” Examples of ‘dial around prefixes’ are 10-10-811 and 10-10-811. This approach further protects the consumer from the unauthorized switching of long distance service, known in the Tele-Communications industry as “slamming.”

Another problem with conventional standard telephone appliances is that they do not allow the user flexibility when selecting a personal prefix, such as a 3-digit area code, intended to be transparently appended to a seven-digit local phone number.

Another problem with several of the conventional standard telephone appliances is that the user has to “flash” (press the hang up or disconnect button) the mechanism in order to switch from long distance mode to local dialing mode.

Another problem with conventional standard telephone appliances is that they do not offer any intuitive feedback to the user as to how the unit is functioning. Thus, users can never be sure exactly what machine function has been activated such as a user mode, programming mode and long distance dial mode.

In these respects, the present inventive solution substantially departs from the conventional concepts, methods and apparatus designs of the prior art, and in so doing provides a method and apparatus for the purpose of the automatic and direct connection of local and long distance phone calls to area code dependent local dialing and predefined long distance service providers' telephone switching equipment by means of transparently and automatically appending the dialed number around prefix numbers.

### SUMMARY OF THE INVENTION

In view of the foregoing disadvantages inherent in the known types of standard telephone appliances now present in the prior art, the present invention provides a method and apparatus for the automatic and direct connection of long distance phone calls to predefined long distance service providers' telephone switching equipment by means of transparently and automatically appending the service provider long distance dial around prefix numbers. This approach protects the consumer against unauthorized switching of the long distance provider at the local switch office. For the subscriber's convenience, the inventive solution also appends a user programmable prefix, such as a three-digit area code, to the normal seven digits dialed in order to place a local phone call. The apparatus is an externally powered stand-alone telephone device that connects between the telephone jack and a standard telephone.

The general purpose of the present invention, which will be described subsequently in greater detail, is to provide a telephone appliance that has many of the advantages of the standard telephone appliances mentioned heretofore and many novel features that result in a new method and apparatus which is not anticipated, rendered obvious, suggested, or even implied by any of the prior art standard telephone appliances, either alone or in any combination thereof.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a method and apparatus that will overcome the shortcomings of the prior art devices.

An object is to provide an automatic telephone dialer for the automatic and direct connection of long distance phone calls to predefined long distance service providers' telephone switching equipment by means of transparently and automatically appending service provider long distance dial around prefix numbers.

Another object is to provide an automatic telephone dialer that provides firewall protection against the unauthorized switching to another long distance service provider.

Another object is to provide an automatic telephone dialer that offers the user flexibility and ease of use when programming a personal prefix, such as a three-digit area code, intended to be appended to the digits normally dialed when making a local call.

Another object is to provide an automatic telephone dialer that enables the user to easily select from different telephone service and programming operation modes of the appliance.

Another object is to provide an automatic telephone dialer that visually indicates the operation mode of the appliance.

Another object is to provide an automatic telephone dialer that does not manipulate or delay the dialing of all well known industry reserved emergency, information and toll free phone numbers.

Another object is to provide an automatic telephone dialer that allows for the long distance service provider dial around prefix numbers to be factory or remotely programmed such that the user can not change the prefix numbers and therefore can not manually override the direct connection of the long distance call to the long distance service provider switch.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a typical telephone arrangement into which the inventive apparatus is connected.

FIG. 2 is a block diagram of the preferred embodiment of the inventive solution.

FIG. 3 illustrates the RAM memory map assignment contained in the Micro Controller.

FIG. 4 illustrates the partitioning of the Micro Controller memory space.

FIGS. 5A-T illustrates the flow charts for the control program of the inventive solution.

### DESCRIPTION OF THE PREFERRED EMBODIMENT

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, an erasable programmable read only memory (EPROM), random access memory (RAM), magnetic and optical storage devices such as disk drives, magnetic tape, CDs (compact discs) and DVDs (digital video discs), and computer instruction signals embodied in a transmission medium (with or without a carrier wave upon which the signals are modulated).

The device, hereto called the Automatic Telephone Dialer (ATD), is programmed in the factory or remotely programmed with at least one long distance service provider's dial around prefix numbers (i.e. 10-10-321) that will be automatically appended to all phone calls beginning with the digit “1.” Normally, the consumer has to dial an additional seven digits, (i.e. 10-10-321) in order to direct a long distance call to a specific long distance service provider's telephone switch. The device eliminates the need for these extra digits by automatically dialing the long distance prefix stored in memory. The device is capable of storing additional prefixes that can be obtained from the unit's memory storage area via a specific soft-key command (the pressing of one or more of the buttons on the telephone handset), may be automatically selected by the internal program of the ATD device.

The ATD protects the consumer against unauthorized long distance service provider switching. Long distance service providers and long distance resellers are notorious for switching consumer's long distance service without authorization. The inventive device subsequently protects the consumer against unauthorized switching of their long distance service. When unauthorized long distance service is configured, it is done so at the local Telco's telephone switch. Since the ATD automatically and directly connects all long distance calls to the predetermined long distance provider's telephone switch, the mal-configured local telephone switch is bypassed. Thus, unauthorized switching is not possible while the device is in service and functioning properly.

The ATD conveniently appends a user programmed prefix. This feature allows the telephone user to return to dialing only seven digits, as opposed to ten or eleven digits that may be required in areas that have added a new area code due to customer demand. The ATD can be easily programmed by the end user to include “any” personal prefix, such as the area code of choice, to be automatically appended to all local calls.

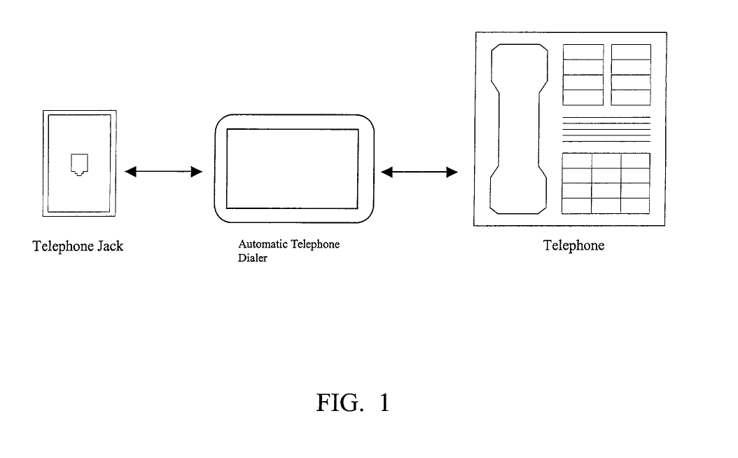

FIG. 1 illustrates a typical telephone arrangement into which the inventive solution is connected between a standard telephone jack and the user telephone. The device captures digits dialed by the telephone by monitoring the activity on the telephone line. As the digits are detected the device determines what intervention is required, if any. When intervention is required, the device initiates a new call, adding the appropriate dialing prefixes as required. The re-dialing process occurs with a minimum amount of delay and is completely transparent to the user. The device is compatible with the standard household and business touch-tone telephone. The device utilizes standard 6-pin modular telephone jacks enabling it to be easily installed without the need for any tools. The device is small and unobtrusive and receives power from a small 110/220 VAC power adapter. The ATD is effectively adapted to other commercial power and telephone connection codes and protocols.

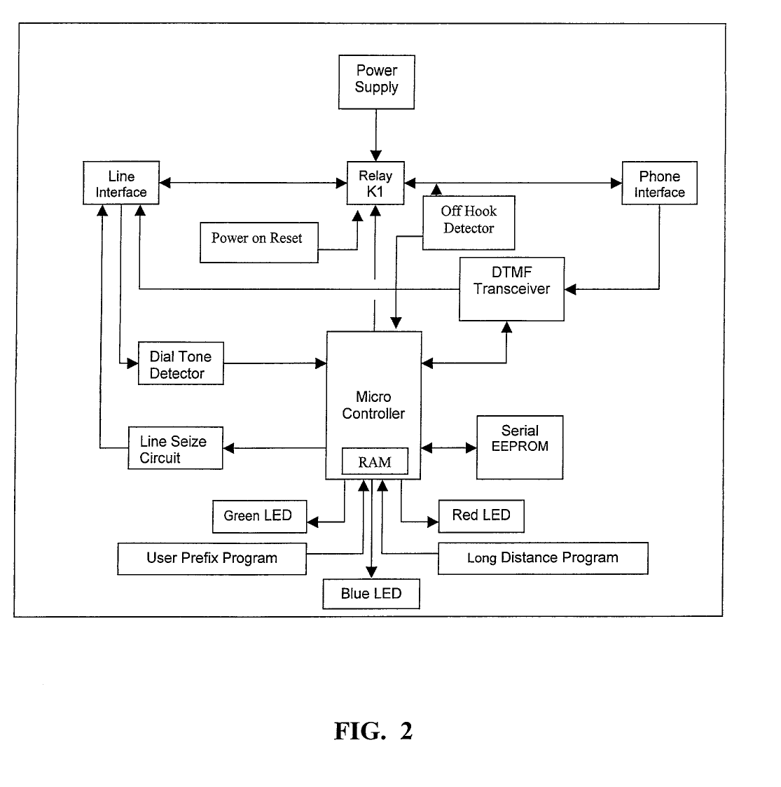

FIG. 2 is a block diagram of the preferred embodiment of the Automatic Telephone Dialer of FIG. 1. The Line Interface provides the electrical connection to the telephone line, including transient protection and noise reduction. Diodes form a full wave bridge to ensure line polarity insensitivity. A solid-state transient voltage protector provides protection from telephone line transients. The Phone Interface provides the electrical connection to the user telephone, including noise reduction and transient protection.

The Relay K1, under direction of the Micro Controller, controls the connection of the telephone to the telephone line. In the de-energized state, the phone is connected to the telephone line and the device is “transparent”. When the Relay is energized, the phone is connected to the internal +12 VDC power supply, via a filtering circuit. This connection insures that the telephone continues to have power during the programming mode and during the re-dial process (Relay energized), and all tones can continue to be generated by the telephone and detected.

The hook status of the telephone is determined by the Off Hook Detector. The detector monitors the telephone line to sense the voltage drop on the line when the user telephone is “picked up” or goes off-hook.

The Line Seize Circuit allows the Micro Controller to initiate a call. This circuit provides this capability either when the telephone is disconnected (via Relay K1) or when the telephone is on on-hook.

The Dial Tone Detector circuit provides an input to the Micro Controller when a dialed tone is detected on the telephone line. The core of this circuit is a M980-01P call progress tone detector integrated circuit by TELTONE or equivalent. Using a 3.58 MHz clock, the IC is sensitive to frequencies between 315 Hz to 640 Hz. A precision dial tone signal is a composite signal formed by summing 350 Hz and 440 Hz.

The dual tone, multifrequency (DTMF) Transceiver is both a DTMF transmitter and a DTMF receiver. Each function operates independently, and interfaces to the micro controller via a 4-bit digital bus. The transmitter is capable of generating all 16 standard DTMF tone pairs in a burst mode with a nominal on and off time of 50 milliseconds. All frequencies are derived from a 3.58 MHz clock. To transmit a pair of tones (digit) to the telephone line, the Micro Controller writes data to the 8888 transmit register. The status of this register (empty or full) is read by the Micro Controller. The output from the transceiver is filtered and then buffered by an amplifier. The output of this amplifier is capacitor coupled to the telephone line and is protected from transients. The DTMF receiver is configured to detect digits generated by the telephone. The receiver input signal originates from the differential amplifier internal to the 8888 which is capacitor coupled to the telephone line. Zener diodes protect the amplifier inputs from telephone line transients. The Micro Controller continuously checks the status of the 8888 receive register (empty or fill). If the register is full, the Micro Controller reads the data via the 4-bit data bus.

The Micro Controller is an 8-bit processing unit; part number AT89C2051-24PC by ATMEL or equivalent, compatible with the standard MCS-51 instruction set, and contains 2k bytes of flash memory. The clock provided to the Micro Controller is 3.58 MHz, which equates to a 3.352 microsecond instruction cycle time. As discussed above, the Micro Controller performs the following functions:

Control Relay K1 to connect and disconnect the telephone from the telephone line.

Read the input from the Dial Tone Detector to determine when a dial tone is present on the telephone line.

Control the Line Seize Circuit to seize the telephone line.

Transmit digits to the telephone line by writing data to the DTMF transmitter.

Read digits from the telephone via the DTMF Receiver.

Reads the input from the Off-hook Detector.

Write data to the EEPROM memory to save (without battery backup) the user define dialing prefix and the long distance dialing prefix.

Controls indicators (LED's) for IN USE, PROGRAM, and BY-PASS MODE.

Reads inputs from the USER program switch and the LONG DISTANCE program switch.

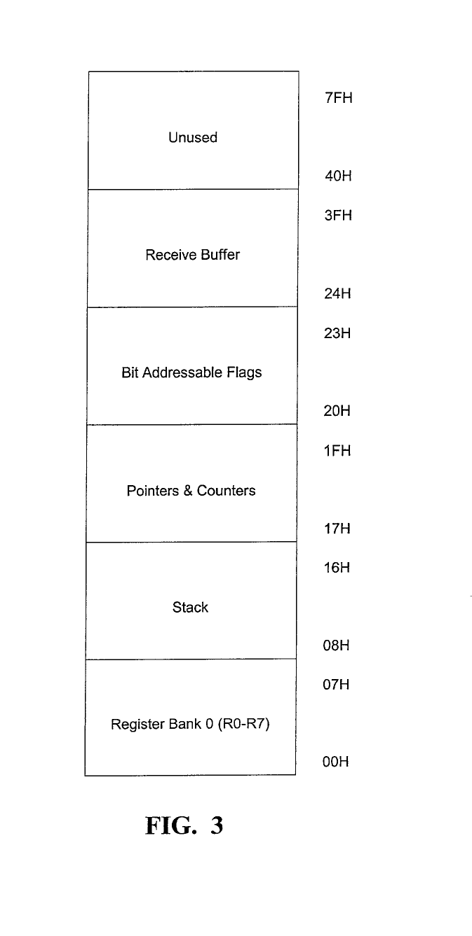

The Micro Controller contains 128 bytes of random access memory (RAM), which is divided into two main sections. The Locations from 00H to 1FH (32 bytes) can be accessed directly with a register reference (i.e. register R0 to R7, in four separate banks) or may be used for general storage. Memory locations from 20H to 2FH are the scratch pad area, and can be used for general-purpose storage. FIG. 3 shows the assignment for the partitioning of the RAM.

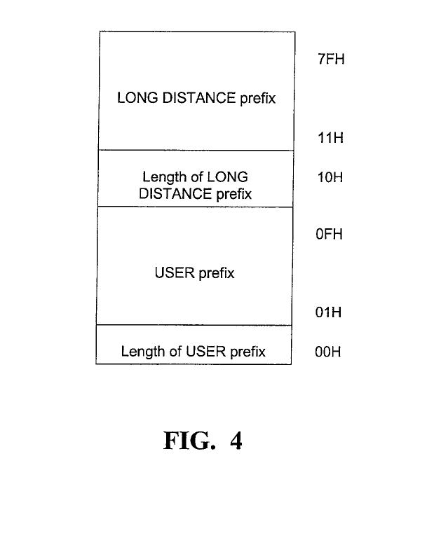

A Serial EEPROM is used by the Micro Controller to permanently store the USER defined prefix and the LONG DISTANCE dialing prefix. The device provides 128 bytes (8 bits each) of non-volatile storage, and is rated for a data retention life of over 100 years with over 1 million erase/write cycles. This device is partitioned into two sections, one for each of the two prefixes. The User prefix is stored within memory locations 01H to 0FH (15 digits max.). Location 00H is a counter indicating the actual length of the USER prefix (i.e. total number of digits) which is either 0 or 3. The LONG DISTANCE prefix is stored within memory locations 11H to 7FH (111) digits max.). Location 10H is a counter indicating the actual length of the LONG DISTANCE prefix (i.e. total number of digits). FIG. 4 indicates the partitioning of the memory space.

The Power Supply is comprised of an external AC to DC converter, which converts the commercial 110/220 VAC to 12 VDC. Internal to the unit, the 12 VDC is filtered and also converted to 5 VDC for the digital logic by a voltage regulator. This regulator is a fixed 5 VDC device providing short circuit current limiting as well as thermal overload protection.

The Micro Controller utilizes three output/input ports to drive a Red light emitting diode (LED), Green LED and a Blue LED. These ports can also be utilized as inputs, and as such are also used to read the state of the programming inputs. To correctly read the input port condition, the output ports must be driven high. The Red LED is used to indicate the USER program mode, and this output/input port is also used to read the USER program switch input. With the LED off, the port is driven high. If the port is read as low, it is assumed that the program switch S1 has been activated. The Green LED is used to indicate the IN USE condition, and this output/input port is also used to read the LONG DISTANCE program switch input. With the LED off, the port is driven high. If the port is read as low, it is assumed that the program switch has been activated. This programming switch is located outside of the device, and is only temporarily present during the programming procedure via the TELEPHONE jack. This jack is a 6-position jack, which utilizes 4 terminals for telephone signals, and the two additional signals for the program switch input (and common). The Blue LED is used to indicate the BY-PASS condition. Although this output/input port can also be used as an input, the input function is currently undefined. A header provides a means to control the input for future expansion.

When power is first applied to the device, the Micro Controller is initialized by a reset signal. A Power on Reset circuit is used to insure that Relay K1 and the Line Seize circuits are not activated during the Micro Controller reset time.

A 3.58 MHz clock signal is required by the 8888 DTMF Transceiver as well as the dial tone detector IC's. To minimize complexity, the Micro Controller also uses this signal as its clock. The signal originates from the 3.58 MHz crystal attached to the oscillator internal to the 8888 DTMF Transceiver. This clock signal is routed to the Micro Controller which then provides a buffered clock signal output that is routed to the Dial Tone Detector.

Modes of Operation

The ATD can assume several different modes of operation at any particular time. In the NORMAL mode, the unit is monitoring digits dialed by the user, and executes its primary function, the re-dial algorithm. The BY-PASS mode is a sub mode of the NORMAL mode, and is essentially a mode when the re-dial algorithm is temporarily suspended for the current call.

Another mode is the USER program mode. In this mode, the unit continues to monitor digits dialed by the user, but instead of executing the re-dial algorithm, the digits are stored in EEPROM memory as the three-digit user defined prefix (area code).

Another mode is the LONG DISTANCE program mode. In this mode, the unit continues to monitor digits dialed, but instead of executing the re-dial algorithm, the digits are stored in EEPROM memory as the long distance prefix. The entrance to this mode can be restricted to prevent alteration of the factory or remotely programmed dial around prefix numbers.

When the ATD is in either of the two program modes, the telephone is disconnected from the telephone line and as such, the digits dialed by the telephone are not applied to the telephone line. Under this condition, the device sources the voltage necessary for the telephone to continue to generate tones.

In order for the device to operate properly, the following assumptions regarding the format of telephone numbers are made:

All long distance calls must be preceded by the digit “1.” (or an optional soft-key command).

All long distance prefixes will begin with the digit “1”. (international calls may be an exception if programmed as an optional prefix)

The # key is not used as the first digit of any call placed by the user.

A dial tone will be available within 5 seconds of the telephone going off-hook.

Dial tone frequency(s) fall between 315 Hz to 640 Hz.

This unit will be attached to a telephone line providing DTMF (i.e. touch-tone) service.

A local call is defined as any call that uses the traditional 7-digit telephone number. Assuming that the device has a USER prefix defined, whenever a local call is made, the device will re-dial the same telephone number with the 3-digit USER prefix. This feature is optional and can be disabled permanently by setting the USER prefix to ###, or temporarily on a call-by-call basis by preceding the 7-digit telephone number with #.

A long distance call is defined as any telephone number (regardless of length) that starts with the digit “1.” Under this condition, the device will re-dial the telephone number captured, preceded with the appropriate LONG DISTANCE prefix, (if more than one is available) stored in memory.

The following table summarizes the operation of the device under various dialing scenarios. The first and second column of the table indicates the data that is input to and output from the device, respectively. Note that under some conditions (identified by Note 1), the device remains completely transparent (i.e. the number dialed by the telephone is sent directly to the telephone line without any delay or intervention by the device).

Summary of Operation

| User Dials | ATD Dials | Results | Comment |
|---|---|---|---|
| 7 Digit Number | UP + 7 Digit | Call Completed | Normal operation. |
| | Number | | UP read from |
| | | | memory. |
| 1 + AC + 7 | LDP + 1 + AC + 7 | Call Completed | Normal operation. |
| Digit Number | Digit Number | | LDP read from |
| | | | memory. |
| 911 | 911 (note 1) | Call Completed | Dialed with no |
| | | | delay |
| 411, etc. | 411, etc. | Call Completed | Dialed with |
| | | | minimal delay |
| 1 + TF + 7 | 1 + TF + 7 | Call Completed | No intervention. |
| Digit Number | Digit Number | | |
| | (note 1) | | |
| 0 (or any num- | 0 (or any number | Call Completed | No intervention. |
| ber starting | starting with 0) | | |
| with 0) | | | |
| * + Any num- | * + Any number of | Call Completed | No intervention. |
| ber of digits | digits (note 1) | | |
| LDP₁ + 1 + | LDP + LDP₁ + 1 + | Call not | Re-dialed number |
| AC + 7 | AC + 7 Digit | completed. | invalid due to two |
| Digit Number | Number | Possible error | LDP's. |
| | | message from | |
| | | LDP provider. | |
| 1 + 7 Digit | LDP + 1 + 7 Digit | Call not | User number |
| Number | Number | completed. | invalid due to |
| | | Possible error | missing AC. |
| | | message from | |
| | | LDP provider. | |
| AC + 7 Digit | UP + AC + 7 Digit | Call not | User number |
| Number | Number | completed. | invalid due to |
| | | Possible error | missing 1 before |
| | | message from | AC. |
| | | LDP provider. | |
| TF + 7 Digit | TF + 7 Digit | Call not | No intervention. |
| Number | Number | completed. | Missing 1 before |
| | | Possible error | TF. |
| | | message from | |
| | | LDP provider. | |
| # + Any num- | The same number, | Call may or | The unit is trans- |
| ber of digits | without the first # | may not be | parent, inserting |
| that does not | | completed. | no additional |
| start with 1. | | | digits. This is the |
| | | | By-Pass mode. |
| # + Any num- | LDP + Any number | Call may or | If the first digit |
| ber of digits | of digits that does | may not be | after the # is 1, |
| that does start | start with 1. | completed. | the By-Pass mode |
| with 1. | | | is exited and |
| | | | operation contin- |
| | | | ues as if the # |
| | | | was not dialed. |

Key:
LDP = Long Distance Prefix (i.e. 10-10-321)
UP = User Prefix (i.e. 3 digit Area Code)
AC = Area Code
Toll Free (i.e. 800, 900, etc.)
Note 1:
The Telephone Auto Dialer does not re-dial this number. It is applied to the telephone line directly by the telephone without modification or delay.

The following table illustrates some examples of the various dialing scenarios. For these examples, assume the user area code is set to 212 and the long distance prefix is set to 1010321 (i.e. 10-10-321).

Dialing Examples

| | Telephone Number | | |
|---|---|---|---|
| | applied to | | Re-dial |
| Telephone Dials | Telephone Line | Valid Call | Required |
| 555-1212 | 212-555-1212 | Yes | Yes |
| 1-505-555-1212 | 10-10-321-1-505-555- | Yes | Yes |
| | 1212 | | |
| 911 | 911 | Yes | No |
| 411, etc. | 411, etc. | Yes | Yes |
| 1-800-555-1212 | 1-800-555-1212 | Yes | Yes |
| 0 | 0 | Yes | No |
| *68 | *68 | Yes | No |
| 10-10-345-1-727-555- | 10-10-321-10-10-345-1- | No | Yes |
| 1212 | 727-555-1212 | | |
| 1-555-1212 | 10-10-321-1-555-1212 | No | Yes |
| 505-555-1212 | 212-505-555-1212 | No | Yes |
| 800-555-1212 | 800-555-1212 | Yes | Yes |
| # 555-1212 | 555-1212 | Yes | No |
| # 10-10-345-1-727- | 10-10-321-10-10-345-1- | No | Yes |
| 555-1212 | 727-555-1212 | | |

The ability of the ATD to append a dialing prefix in front of a telephone number is accomplished by temporarily storing the number captured from the telephone as the call is being made, while canceling the call in progress but still allowing the telephone to operate normally. A new call is then made using the temporarily stored telephone number (captured from the telephone) with the addition of the appropriate prefixes. The time required to initiate a new call is approximately 1.7 seconds. The actual delay as perceived by the user is a function of how fast the user dials the telephone. The slower the number is dialed by the user, the less noticeable the delay.

Three light emitting diode (LED) indicators are provided on the front panel to denote the various operating modes of the device. The colors of the LED's, RED, GREEN, and BLUE, have been selected for clear description of the invention. The actual colors could easily be changed without effecting the operation of the invention. The RED (Program) LED indicates the USER program mode has been activated. This LED is extinguished either when the USER defined prefix has been successfully programmed or when the programming mode has been aborted. The GREEN (In Use) LED indicates either the LONG DISTANCE program mode has been activated or when the device is in the process of re-dialing a telephone number. This LED is extinguished when the LONG DISTANCE prefix has been successfully programmed, the programming mode has been aborted, or the re-dial process is complete. The BLUE (By-Pass) LED indicates the By-Pass mode has been activated and is extinguished when the By-Pass mode is exited.

Operation

The Automatic Telephone Dialer is primarily designed to automatically connect and direct long distance phone calls to predefined long distance service providers' telephone switching equipment by means of appending a pre-defined prefix in front of some numbers captured from the telephone. Initially, all user dialed digits are applied directly to the telephone line. This insures that the device adds no additional delay when high priority numbers such as 911 are dialed. However, when a low priority number is dialed, the ATD adds a prefix by canceling the current call in progress, establishes a new call, and re-dials the same telephone number with the addition of the appropriate dialing prefixes.

The re-dial algorithm is responsible for determining if, when and which prefix should be added to a telephone number, and is executed only when the unit is in the NORMAL mode. The NORMAL mode is defined by not being in either the USER program mode or the LONG DISTANCE program mode.

The device monitors the digits dialed by the telephone as they are applied to the telephone line. The re-dial algorithm determines when the device should intervene and modify the number applied to the telephone line.

If the device determines that the telephone number dialed by the user should be modified, the telephone is disconnected from the telephone line and the line is released allowing a new call to be placed. Under this condition, the device will source the necessary voltage to the telephone so that the user may continue to dial the telephone number desired, and the device will continue to capture the entire number. Assuming that both a LONG DISTANCE prefix and a USER prefix are stored in memory, the original number dialed by the user is re-dialed by the device, with the addition of the appropriate long distance or user defined prefix.

As each digit is read from the telephone line, the re-dial algorithm processes this new data, along with any previous data, to determine if intervention is required. If the re-dial algorithm determines that no intervention is required, the unit is “shut down” (i.e. the program is essentially halted) and waits for the telephone to go on-hook. Under this condition, the unit is completely transparent, i.e. all digits dialed by the telephone go directly to the telephone line and the device takes no further action. The algorithm will execute again only after an on-hook to off-hook transition is detected, which signals that a new call is being placed.

The following is a summary of the re-dial algorithm actions:

If the first digit dialed is “0” or “*”, the unit is shut down.

If the first three digits are “911”, the unit is shut down.

If the first three digits are “411, 311, 800, 866, 877, 888, or 900”, the unit is shut down (exception cases).

If the first four digits are “1-911, 1-311, 1-800, 1-877, 1-888 or 1-900”, the unit is shut down (exception cases).

The re-dial algorithm determines the course of action after each digit is detected from the telephone line (in contrast to waiting for the entire number to be dialed before any processing occurs). This insures that the re-dial delay is kept to a minimum. The following scenarios describe the normal operation of the unit (i.e. not in either of the program modes and not in the BY-PASS mode) and the actions taken after each digit is detected:

After the First Digit is Dialed:

1) If the first digit is “0”, then the unit is shut down.

2) Else if the first digit is “*”, then the unit is shut down.

3) Else if the first digit is “1”, then start the re-dial process.

4) Else wait for second digit.

After the Second Digit is Dialed:

1) If the second digit is “1”, AND the first digit is “9”, then wait for third digit.

2) Else start the re-dial process if not already started.

After the Third Digit is Dialed:

1) If the third digit is “1” AND the second digit is “1” AND the first digit is “9”, then the unit is shut down.

2) Else if the first three digits equal an exception case, then re-start the re-dial process without any prefix.

3) Else start the re-dial process if not already started.

After the Fourth Digit is Dialed:

1) If the first digit is “1” AND the second, third, and fourth digits equal an exception case, then re-start the re-dial process without any prefix.

2) Else end the re-dial algorithm.

When the re-dial algorithm is complete, the only task left to perform is to dial any remaining digits captured from the telephone line. Once all captured digits have been dialed, the device is shut down. Note that this may not necessarily be when a complete telephone number has been re-dialed, only when all digits captured have been re-dialed. Any remaining digits required to complete the telephone number will be applied to the telephone line directly from the telephone, without any further intervention from the device.

The term “shut down”, when used above indicates the device does not modify the telephone number applied to the telephone line by the telephone in any way shape or form, or with any delay whatsoever.

In an effort to keep the dialing delay to a minimum for the majority of the telephone calls, it may be necessary to re-start the re-dial process as additional digits are detected from the telephone. For example, if the first digit detected is an 8, the re-dial algorithm assumes that the number will not be a special case as defined in the exception table. If however, after the third digit is detected, the first three digits are an exception case (i.e. 800), then the re-dial algorithm will determine that a different course of action is required, and the re-dial process must be re-started. When this condition occurs, a new call must be initiated. The dialing delay under this scenario will be slightly longer, and is a function of the speed at which the user dials the first three digits of the telephone number. The dialing delay will then be approximately 1.7 seconds after the exception case has been detected.

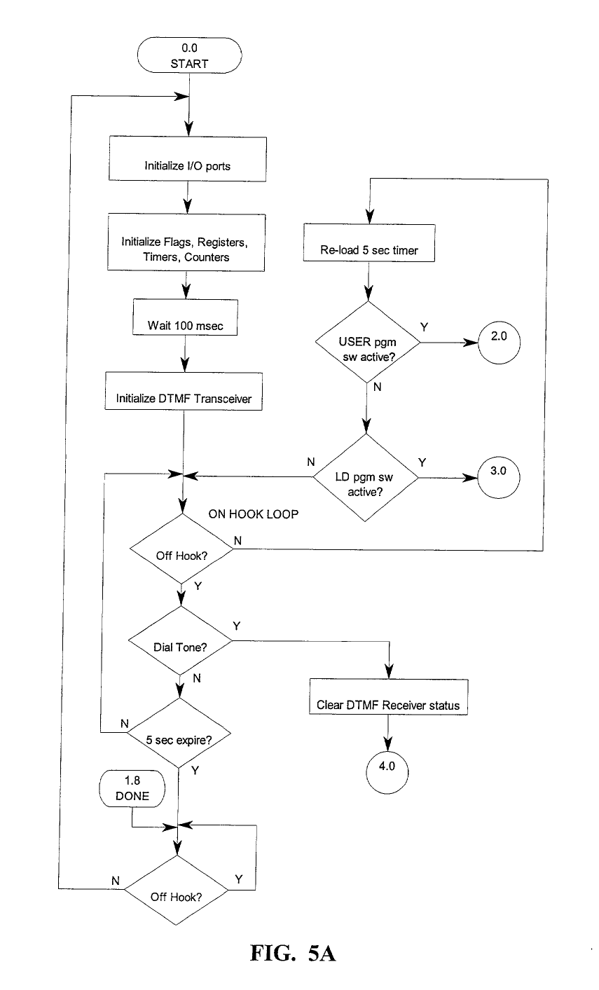

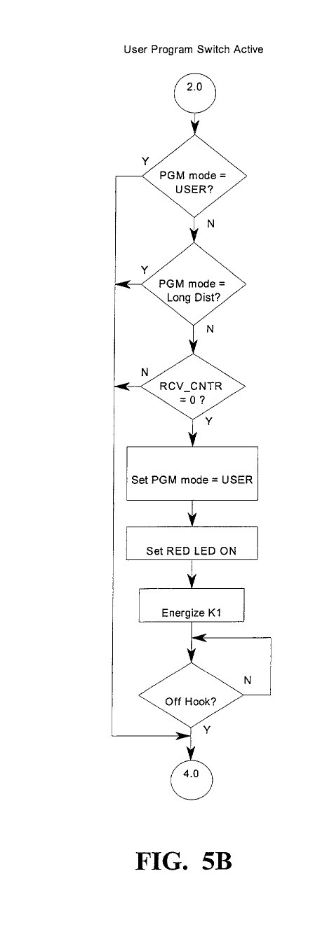

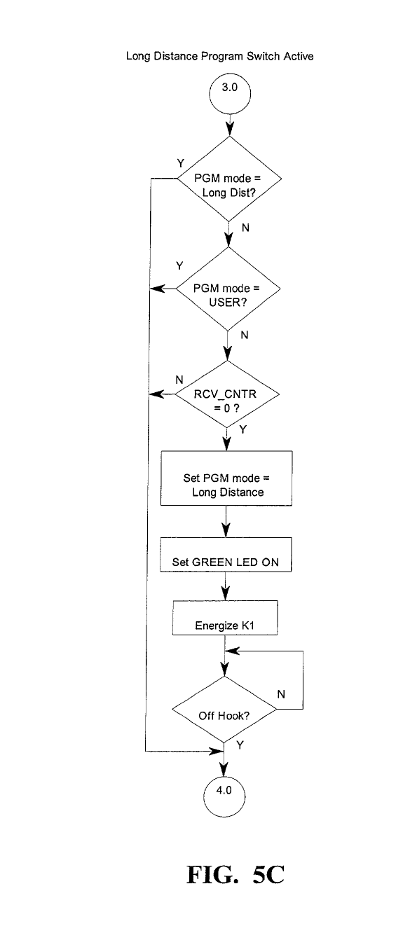

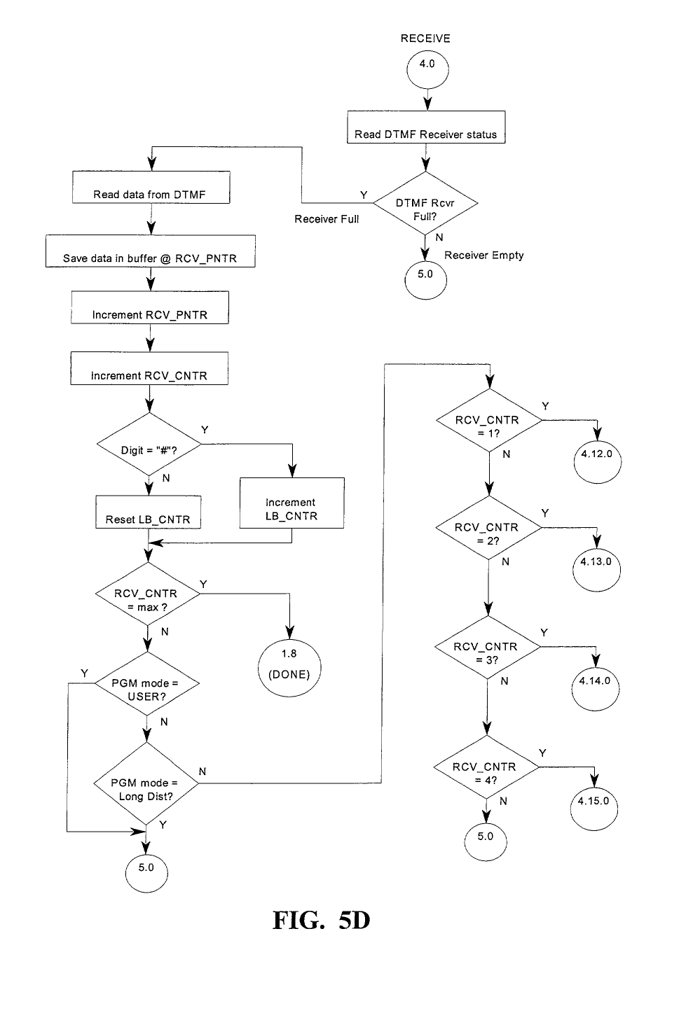

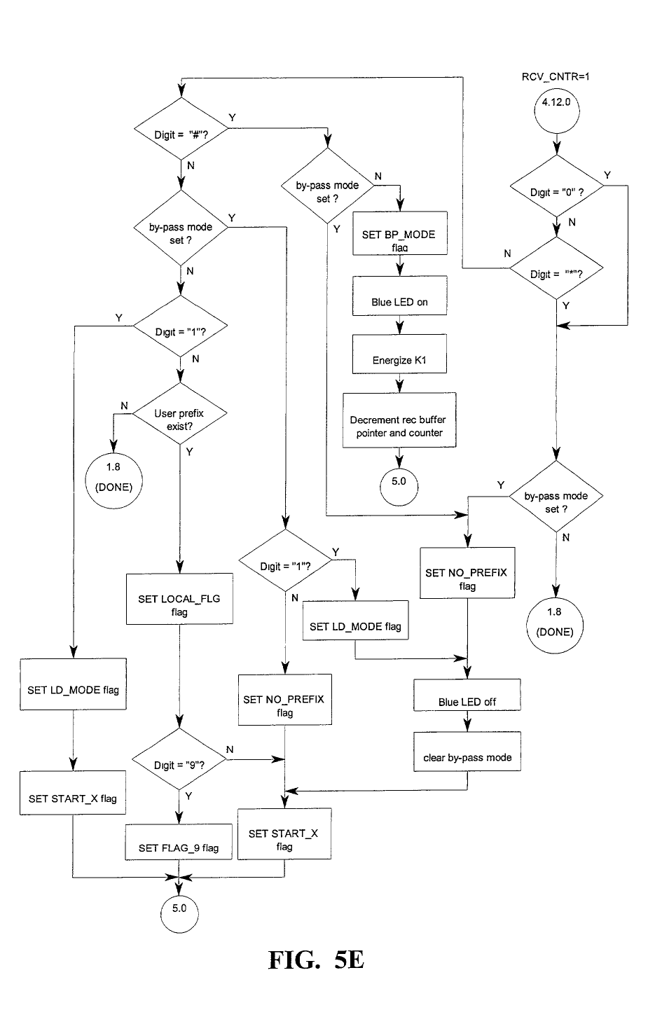

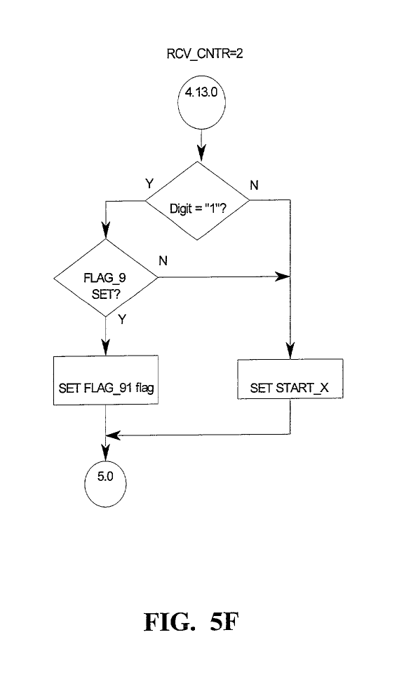

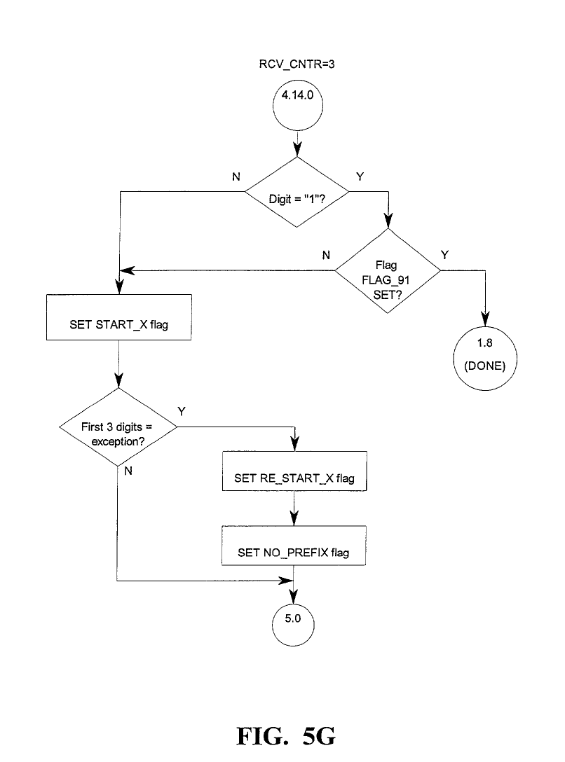

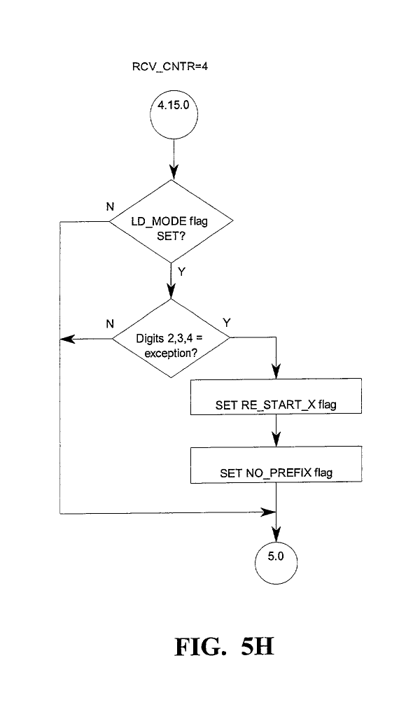

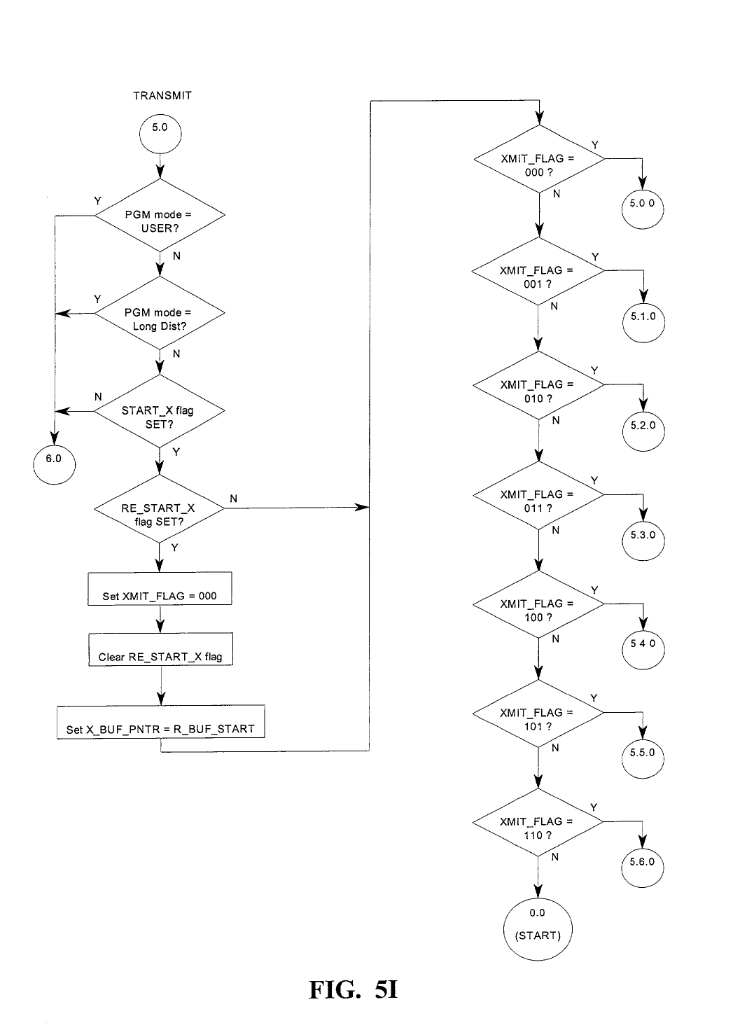

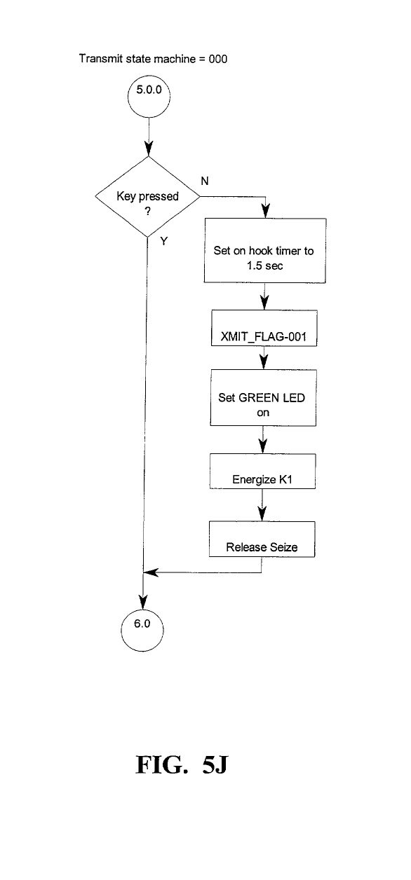

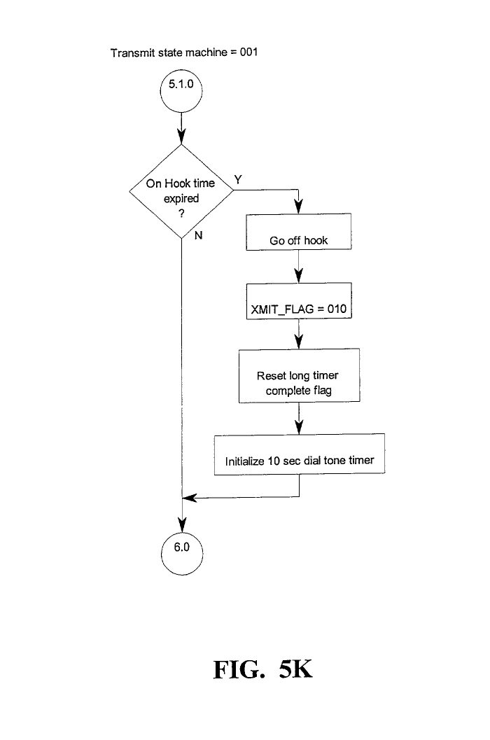

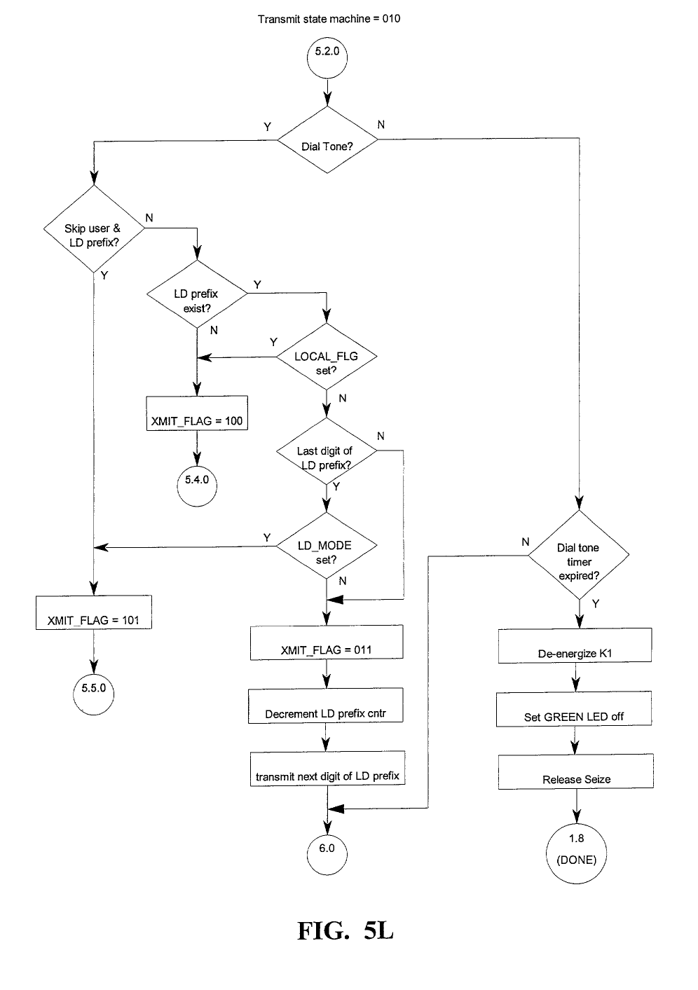

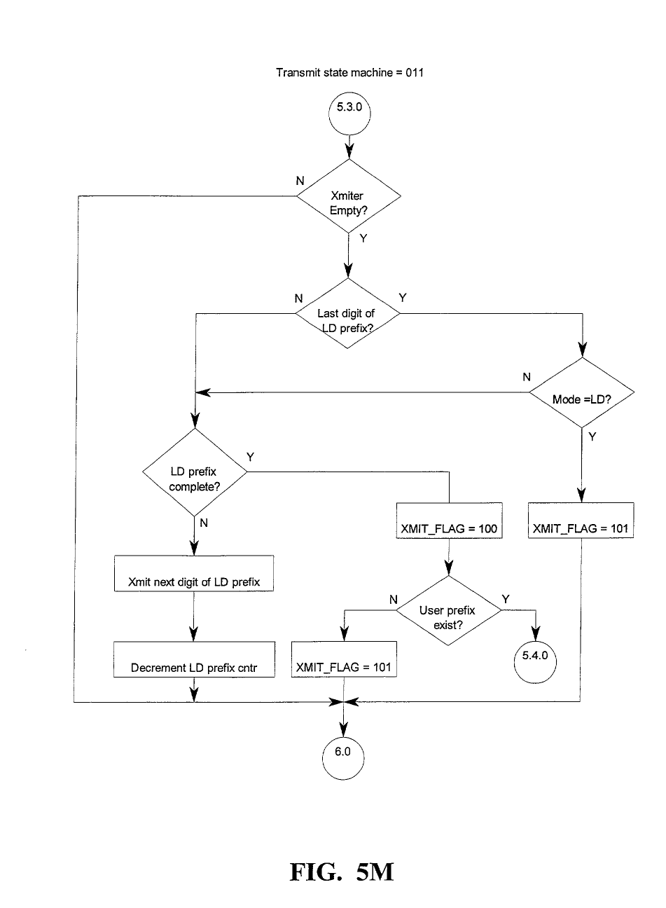

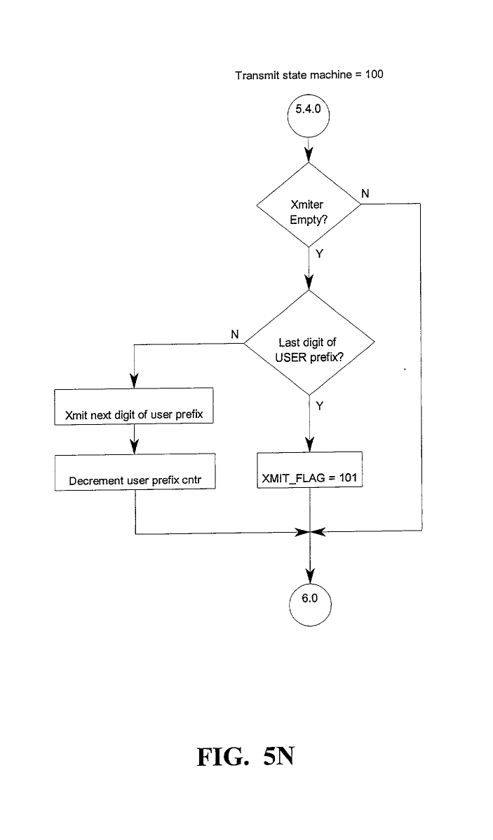

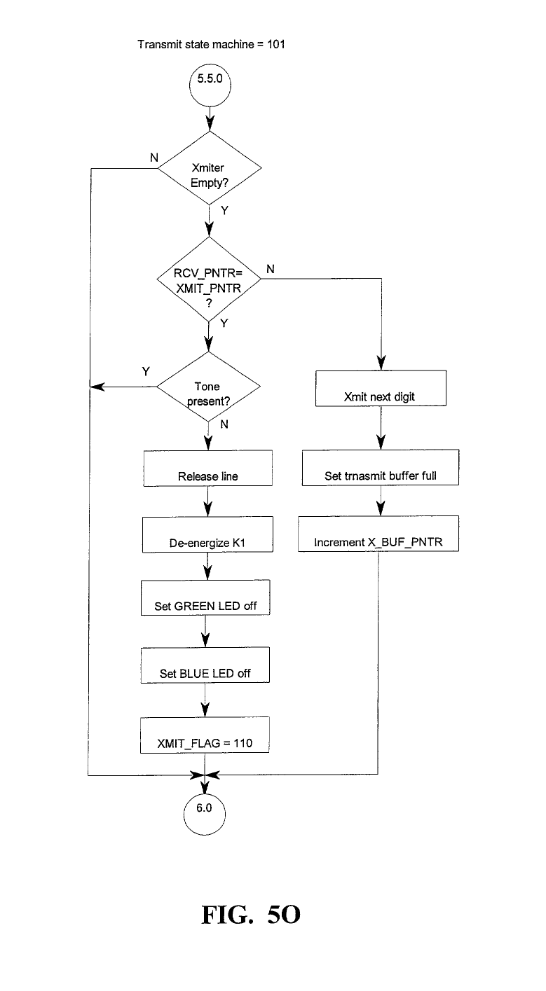

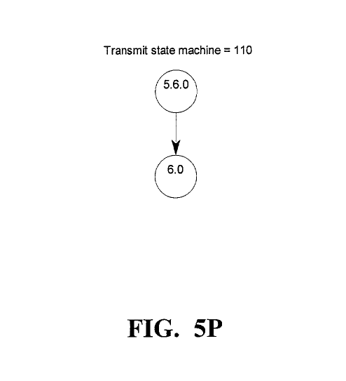

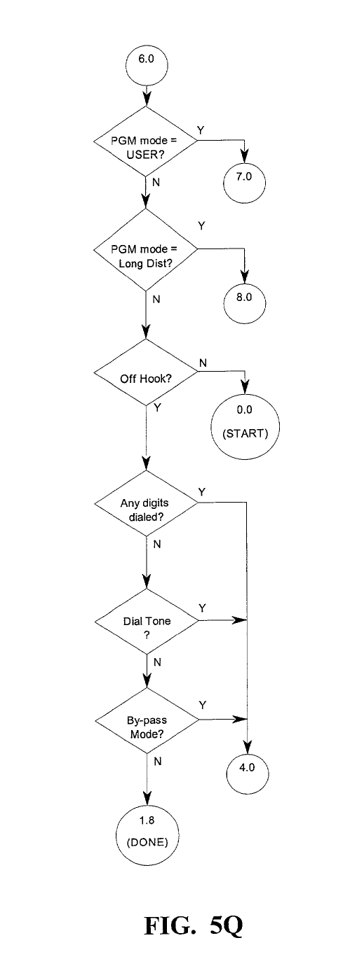

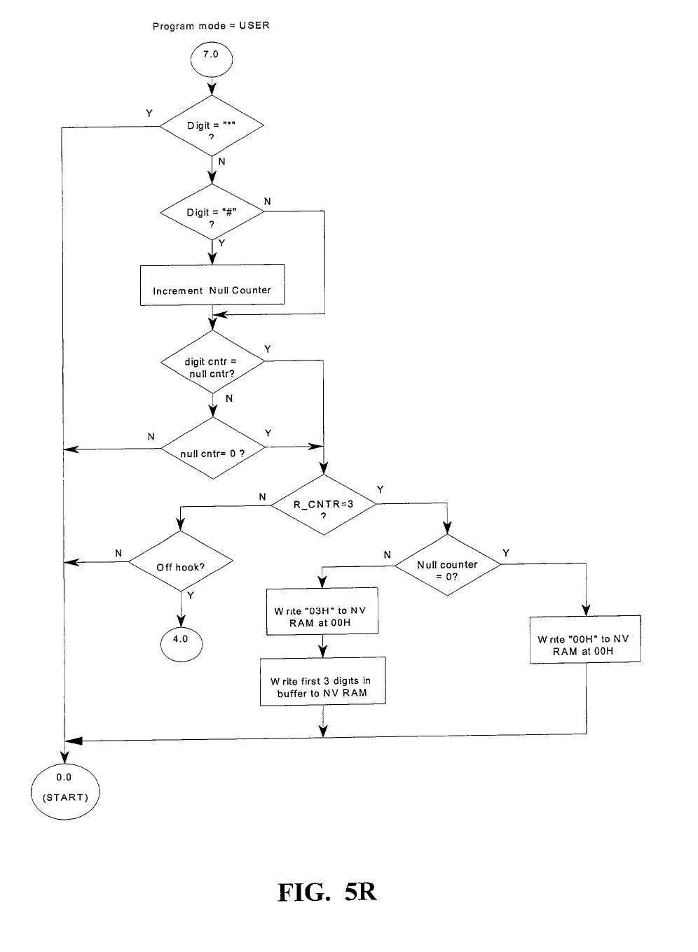

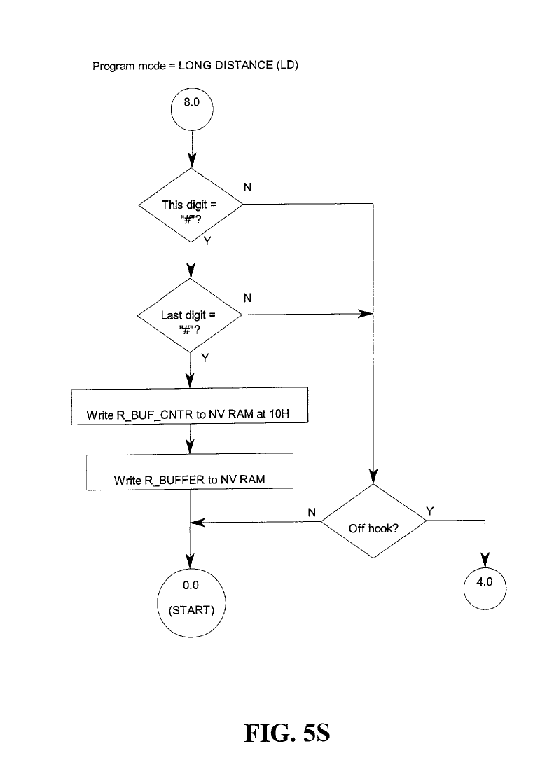

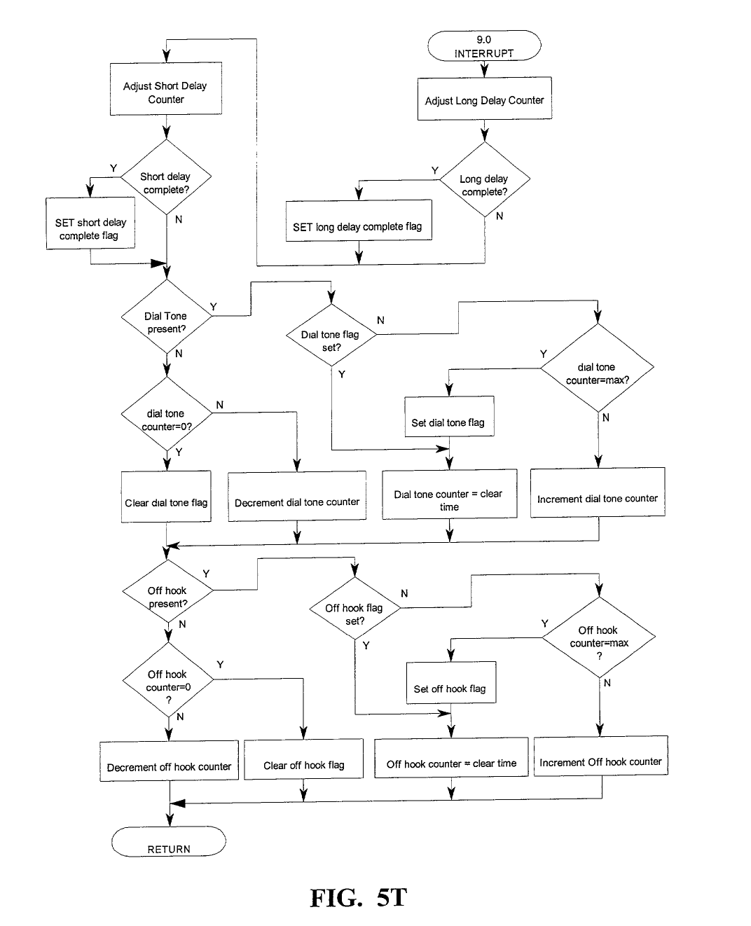

The program of the ATD is divided into two primary functions: receiving digits dialed by the user, and dialing digits to the telephone line. In the normal state, the unit executes an algorithm (the re-dial algorithm) that monitors the digits dialed by the user and determines what intervention is required, if any. This section describes the execution of the micro controller program, including the details of the re-dial algorithm. FIGS. 5A-U contains a flow chart that graphically depicts the operation as described below.

In the NORMAL mode, the software executes two loosely coupled routines, the RECEIVE routine and the TRANSMIT routine. The RECEIVE routine is responsible for monitoring the digits dialed by the user and temporarily storing them in memory. The TRANSMIT routine is responsible for the transmission (re-dialing) of digits to the telephone line (if required). Under normal conditions, the RECEIVE and TRANSMIT routines execute concurrently, performing its own tasks independent of the other routine. The RECEIVE routine is also utilized when the unit is placed in either of the two programming modes.

FIG. 5A: Start Up

When power is first applied to the unit, a hardware-reset signal causes the program to initialize to address 000H. The first section of code initializes all internal memory locations, all hardware ports, and the 8888 DTMF transceiver. The following table shows the initialized states of the various hardware items:

Hardware Initialized States

| Item | State |
|---|---|
| 8888 | DTMF operation, burst mode |
| Relay K1 | De-energized (telephone connected to the telephone line) |
| RED LED | Off |
| GREEN LED | Off |
| BLUE LED | Off |
| SEIZE | The telephone line is released |

After initialization is complete, the program executes a small loop waiting for the OFF-HOOK signal to go active (indicating the user has lifted the telephone off the hook) and that a dial tone has been detect from the telephone line. Until this condition is detected, no further processing is executed, with the exception of monitoring the USER program switch input and the LONG DISTANCE program switch input. Once the telephone is detected as being off-hook, a dial tone signal must be detected within 5 seconds (if the unit is not in the USER or LONG DISTANCE program modes). If a dial tone is not detected within 5 seconds, program execution is halted, and no further action is taken until the next call is placed. If a dial tone is detected (within 5 seconds), execution continues with the RECEIVE routine.

Done <1.8>

After the unit has completed its required tasks for the current call, the program is halted until the start of the next call is detected. This halting of program execution is accomplished by running a tight loop, which does nothing more than check to see if the telephone has gone on-hook (hung up). Once the telephone is detected on-hook, the program is re-started at the address 000H.

Various single bit flags are used throughout the program to represent various intermediate conditions during the execution of the program. The following table identifies these flags and their function.

Flag Definition

| Name | Function | Set When . . . |
|---|---|---|
| NO_PREFIX | Indicates that neither the | BY-PASS mode is se- |
| | USER or LONG | lected (i.e. first digit |
| | DISTANCE prefix | received is [symbol] ) |
| | should be used | |
| LD_MODE | Indicates user has dialed | First digit received is \mathring{1} |
| | a long distance number | |
| FLAG_9 | \mathring{9}\mathring{1}\mathring{1} detection | First digit received is \mathring{9} |
| LD_PGM_MODE | User has placed the unit | Long distance program |
| | in the LONG DIS- | mode is active |
| | TANCE program mode. | |
| PGM_MODE | User has placed the unit | User program mode is |
| | in the USER program | active |
| | mode. | |
| FLAG_91 | \mathring{9}\mathring{1}\mathring{1} detection | First digit received is \mathring{9} |
| | | and second digit received |
| | | is \mathring{1} |
| START_X | Start the re-dial | The re-dial process |
| | process | should be started |
| RE_START_X | Re-start the re-dial | The re-dial process |
| | process | should be re-started |
| X2_FLAG | Doubles the interrupt | Every other call to the |
| | time | interrupt routine |
| BP_MODE | Indicates the user has | The BY-PASS mode is |
| | selected the BY-PASS | active |
| | mode | |
| LT_DELAY | Long delay timer status | Long delay is complete |
| HOOK_SW_DB | Detects the de-bounced | Telephone is off-hook |
| | hook status of the tele- | |
| | phone | |
| DIAL_TONE_DB | Detects the de-bounced | Dial tone is present |
| | dial tone status of the | |
| | telephone line | |
| XMTR_EMPTY | Status of 8888 DTMF | Buffer is empty |
| | receiver | |
| TONE_FLG | Detects if the user is | 8888 DTMF receive is |
| | pressing a key on the | actively detecting a tone |
| | telephone | |
| ST_DELAY | Short delay timer status | Short delay is complete |
| LOCAL_FLG | Indicates if the user has | The first digit received is |
| | dialed a local call. | not \mathring{1} and the USER |
| | | defined prefix exists. |

FIG. 5D: Receive Routine

The RECEIVE routine reads the 8888 DTMF receiver to monitor the digits dialed by the telephone. When the 8888 indicates that the receiver is full (i.e. a digit has been detected), the RECEIVE routine reads the data and places it in a RAM table identified as the receive buffer (RCV_BUF). Two memory locations perform the housekeeping functions for this buffer, the receive buffer pointer (RCV_PNTR) and the receive buffer counter (RCV_CNTR).

The receive buffer pointer is used to indicate the next available memory location in the receive buffer and is initialized to the bottom of the buffer. As data is added to the buffer, the pointer is incremented to point to the next available location.

The receive buffer counter keeps track of how may data values (digits) are added to the buffer, and is initialized to 0. As data is added to the buffer, the counter is incremented. The re-dial algorithm utilizes the receive counter to determine where each digit fits into the overall number dialed by the user. As each digit is read, the value of the receive buffer counter is checked to insure that the buffer does not overflow. If the counter reaches 29, the program is halted (i.e. the maximum size of the receive buffer is 28 digits deep).

The pound key “#” is utilized in the LONG DISTANCE program mode to signal the end of data entry. As each digit is placed into the receive buffer, it is checked to see if it is “#.” A counter (LB_CNTR) is used to keep track of the number of consecutive occurrences of “#.” With each occurrence, the counter is incremented. If the current digit is not “#,” the counter is reset to 0.

The value of the receive buffer counter (RCV_CNTR) is tested to determine what intervention the device will have on the current call. Depending upon the value of the digit, and its position in the telephone number sequence (i.e. first, second, third, or fourth digit), the logic may do one or more of the following:

Halt program execution.

Change the mode of operation (i.e. normal or program mode).

Start the re-dialing process.

Re-start the re-dial process.

Continue without action, waiting for the next digit.

Set various flags and continue on.

FIG. 5E: RCV_CNTR=1

This section of code is executed after the first digit is detected from the telephone.

If the first digit is “0” or “*,” and the BY-PASS mode is not active, the unit is shut down. If the first digit is “#” and the BY-PASS mode is not set, the BY-PASS mode flag is set, the receive buffer pointer and receive buffer counter are decremented (i.e. the next digit will now become the first digit), the BLUE LED is illuminated, and the K1 relay energized. If the first digit is “#” and the BY-PASS mode is set, the BY-PASS mode is exited and no prefixes are appended to the telephone number. If the first digit is “1” and the BY-PASS mode is set, the BY-PASS mode is exited and the re-dial algorithm continues as if the telephone number starts with “1.” If the first digit is “1,” then start the re-dial process and set the long distance flag (LD_MODE). If the first digit is “9,” wait for the second digit (911 may be dialed). Else wait for the second digit.

FIG. 5F: RCV_CNTR=2

This section of code is executed after the second digit is detected from the telephone. If the second digit is “1,” AND the first digit is “9,” then wait for third digit (911 may be dialed). Else start the re-dial process if not already started.

FIG. 5G: RCV_CNTR=3

This section of code is executed after the third digit is detected from the telephone. If the third digit is “1,” AND the second digit is “1,” AND the first digit is “9,” then the unit is shut down. Else if the first three digits equal an exception case, then re-start the re-dial process without any prefix. Else start the re-dial process if not already started.

Exception checking is performed by the re-dial algorithm to determine if a special case number (i.e. a “toll free” number) has been dialed by the user. Under this condition, the device should not intervene with any dialing prefix. The exception numbers are stored in an exception table (EX_TABLE). The total number of three digit exceptions is stored as the first value in the table.

The exception subroutine (EXCEPTION) determines if there is a match between any of the values in the exception table and the previous three digits in the receive buffer (RCV_BUF) pointed to by the receive buffer pointer (RCV_PNTR). If a match is found, a return code of 01 is written to register R0. If a match is not found a return code of 00 is written to register R0.

FIG. 5H: RCV_CNTR=4

This section of code is executed after the fourth digit is detected from the telephone. If the fourth digit is “1,” AND the second, third, and fourth digits equal an exception case, then re-start the re-dial process without any prefix. Else end the re-dial algorithm.

FIG. 5I: Transmit

This section of code, termed the transmit routine, is responsible for sending data (digits) to the telephone line by controlling the 8888 DTMF transmitter. By reading the status register in the 8888, the state of the 8888 transmitter (empty or full) is determined. The transmitter can only hold one digit at a time, and must be reloaded with the next digit when empty. The TRANSMIT routine also controls the following hardware functions:

Connecting or disconnecting the telephone from the telephone line by controlling the K1 Relay.

Seizing or releasing the telephone line.

Controlling the RED (in use) LED.

Data (digits) to be transmitted will normally come from three separate locations: 1) The LONG DISTANCE prefix stored in EEPROM, 2) The three digit area code (USER prefix) which is also stored in EEPROM, and 3) The original number dialed by the user, which is temporarily stored in a RAM buffer (RCV_BUF) by the RECEIVE routine.

A state machine is utilized to control the flow of the TRANSMIT routine. A three bit flag is used to keep track of the 7 various states the machine can attain. Each state or phase of the state machine performs a specific task, as listed in the following table:

Transmit Routine State Machine Summary

| State | Flag | Description |
|---|---|---|
| A | 000 | Initial state. The telephone line is released, the telephone |
| | | disconnected from the telephone line, and a 1.5 second |
| | | timer is initialized. |
| B | 001 | Wait until 1.5 seconds expire, then seize the telephone line |
| | | while the telephone remains disconnected from the tele- |
| | | phone line. Initialize 10 second timer |
| C | 010 | Wait until dial tone is detected (10 seconds max.). Start the |
| | | re-dial process. |
| D | 011 | Continue the re-dial process until the LONG DISTANCE |
| | | prefix is complete. |
| E | 100 | Continue the re-dial process until the User defined prefix is |
| | | complete. |
| F | 101 | Continue the re-dial process until the RECEIVE buffer is |
| | | empty. |
| G | 110 | The re-dial process is complete. |

The following table indicates the various states executed for the different types of telephone calls. All call types start with State A (flag=000) and finish in State G (flag=110). The number shown in each column indicates the sequence of states, starting with step 1 and ending with either step 3 or 4. The states identified with “X” are not executed for that particular type of call.

Transmit Routine State Machine Path for Various Call Types

| | State | | | | | | |
|---|---|---|---|---|---|---|---|
| Call Type | 000 | 001 | 010 | 011 | 100 | 101 | 110 |
| Local | Start | 1 | 2 | X | 3 | 4 | Finish |
| Long Distance | Start | 1 | 2 | 3 | X | 4 | Finish |
| Local with By-Pass | Start | 1 | 2 | X | X | 3 | Finish |
| Long Distance with By-Pass | Start | 1 | 2 | 3 | X | 4 | Finish |

FIG. 5J: Transmit State A (Flag=000)

This is the first step in the re-dialing process. In order to place a new call (with the appropriate prefixes) the line must be released. Relay K1 is energized, which disconnects the telephone from the telephone line. With K1 energized, the device now sources the voltage necessary to power the telephone. Prior to energizing K1, the 8888 DTMF receiver is tested to insure that a tone (digit) is not currently being detected. This insures that relay K1 will only change states when a key on the telephone is not depressed (a tone not being transmitted by the telephone). The RECEIVE routine continues to process any data (digits) that may be detected. A software timer (on-hook timer) is initialized to 1.5 seconds and the GREEN LED is illuminated. After this state is completed, and the state flags are incremented to State B (flags =001).

FIG. 5K: Transmit State B (Flag=001)

In this state, the on-hook timer (which was initialized to 1.5 seconds in State A) is check for its terminal count. If the timer has not yet expired, no further processing is performed. When the timer does expired, the telephone line is seized in preparation for making a new call. A new software timer is also initialized, the dial tone timer. This timer is initialized to 10 seconds, and is used to abort the re-dial process if a dial tone is not detected after the timer expires. After this state is completed, the state flags are incremented to State C (flags =010).

FIG. 5L: Transmit State C (Flag=010)

In this state, the dial tone detection hardware is sampled to determine when a dial tone is present. If the dial tone is not present, the dial tone timer (which was initialized to 10 seconds in State B) is check for its terminal count. If the timer has not yet expired, no further processing is performed. If the timer has expired, the re-dialing process cannot continue and must be aborted. The telephone is reconnected to the telephone line, the GREEN LED is extinguished, the telephone line is released, and execution is essentially halted by executing a tight loop, which can only be exited when the telephone goes on-hook (hung up).

If a dial tone is detected before the timer expires (which is the normal condition), the logic in this state checks if the LONG DISTANCE prefix or USER prefix should be dialed. Under some conditions, such as the BY-PASS MODE, neither prefix will be transmitted. The state of the NO_PREFIX flag indicates if the prefixes should be skipped. If the flag indicates that the prefixes should be skipped, the state machine flags are set to State F (flags=101).

If the NO_PREFIX flag indicates one of the prefixes should be dialed, a check is made to insure that a LONG DISTANCE prefix exists. If the LONG DISTANCE prefix does not exist (i.e. was not programmed into EEPROM memory), the state machine flags are set to State E (flags=100). If the LONG DISTANCE prefix does exist, execution continues with a check to see if the LONG DISTANCE prefix should be dialed. This check is based upon the flag LOCAL_FLG, which is set when the first digit received is not “1”, (which indicates a local 7-digit call is in process) and the USER prefix exists. Assuming that the LOCAL_FLG is clear (indicating the user is dialing a long distance number), a check is made to see if the next digit to be transmitted is the last digit of the LONG DISTANCE prefix. If this is not the case, the next digit of the LONG DISTANCE prefix will be read from EEPROM memory and applied to the telephone line, and the state machine flags are set to State D (flags=011).

If the next digit in the LONG DISTANCE prefix is the last digit, a check is made to see if the first digit received was “1.” If this is the case, then the last digit of the LONG DISTANCE prefix (which must be “1,” for correct operation) should be omitted, and the state machine flags are set to State F (flags=101).

Under the condition when the LOCAL_FLG is set (indicating a local 7-digit number is being dialed), the state machine flags are set to State E (flags=100).

FIG. 5M: Transmit State D (Flag=011)

In this state, the transmission of the LONG DISTANCE prefix has already begun. A prefix counter keeps track of how many digits have been sent to the transmitter. If the 8888 DTMF transmitter is not empty, no further processing is performed. If the transmitter is empty, a check is made to see if the next digit is the last digit of the LONG DISTANCE prefix. If the current digit is not the last digit of the prefix, a check is made to see if the prefix is complete. If the prefix is not complete, the next digit of the prefix is read from memory and sent to the transmitter and the prefix counter decrements. If the prefix counter indicates that the next digit in the LONG DISTANCE prefix is the last digit, a check is made to see if the first digit received was “1.” If this is the case, then the last digit of the LONG DISTANCE prefix (which must be “1,” for correct operation) should be omitted, and the state machine flags are set to State F (flags=101).

FIG. 5N: Transmit State E (Flag=100)

In this state, the 8888 DTMF transmitter is filled with data from the USER prefix (area code) stored in EEPROM memory. A prefix counter keeps track of how many digits have been sent to the transmitter. If the transmitter is not empty, no further processing is performed. If the transmitter is empty, a check is made to see if the USER prefix is complete. If it is not, the next digit of the prefix is read from memory and sent to the transmitter and the prefix counter decrements. If the prefix is complete, the state machine flags are set to State F (flags=101).

FIG. 50: Transmit State F (Flag=101)

In this state, the 8888 DTMF transmitter is filled with the number dialed by the user, which was temporarily stored in RAM. The transmit pointer (XMT_PNTR) keeps track of which digits stored in the receive buffer (RAM) have been sent to the transmitter. If the 8888 transmitter is not empty, no further processing is performed. If the transmitter is empty, a check is made to see if the transmit pointer is equal to the receive pointer. If the receive buffer pointer is not equal to the transmit pointer, the next digit of the number is read from memory and sent to the 8888 transmitter and the transmit pointer is incremented.

The condition when the transmit pointer equals the receive buffer pointer indicates that all digits stored in the receive buffer have been transmitted. At this point, the K1 relay could be de-energized, allowing all future digits dialed by the user to be sent directly to the telephone line. The only restriction is that the K1 relay should only change state when a tone is not present (i.e. a key is not being depressed on the telephone). If the relay where allowed to change state when a tone was being generated by the telephone, it may cause the tone to be invalid, due to a short duration. Therefore, if the transmit pointer equals the receive buffer pointer and a tone IS detected, no further processing is performed.

If the transmit pointer equals the receive buffer pointer AND a tone is NOT being detected, Relay K1 is de-energized, restoring the connection between the telephone and the telephone line. The GREEN LED is extinguished, the telephone line is released (since the telephone is once again connected), and the state machine flags are set to State G (flags=110).

FIG. 5P: Transmit State G (Flag=110)

This is the last state of the state machine, and indicates that the re-dialing process is complete. No further processing is performed.

FIG. 5Q: Starting or Re-Starting a Transmission

Two separate single bit flags are utilized to control the transmission process. As the re-dial algorithm executes, the e logic will determine when the transmit state machine should start. By setting the START_X flag, the start of the TRANSMIT routine is initiated. Under some circumstances, it may be necessary to re-start the transmission process that is already in progress. A single bit flag is utilized to indicate that the transmission process should be re-started (RE_START_X). The re-dial algorithm controls both the START_X and RE_START_X flags.

FIGS. 5B and 5R: User Program Mode

The USER program mode is entered when the phone is on-hook AND the user program input is detected as active. When this condition is detected, the K1 R belay is energized, and the RED LED is illuminated. The device sources the voltage applied to the telephone, and the digits dialed by the telephone do not reach the telephone line.

The user defined dialing prefix is a three-digit number selected by the user as the local area code (i.e. the area code assigned to the telephone line by the telephone service provider). Under normal conditions, the user would program this prefix only once during the initial installation. If necessary, this prefix could be changed at a later date if the telephone service provider should change the area code.

After the USER program mode is entered, the next three numbers dialed by the user are read and stored in EEPROM memory as the user define prefix. After the USER prefix is successfully stored, the RED LED is extinguished and Relay K1 is de-energized, which re-connects the telephone to the telephone line. If the telephone is hung up (goes on-hook) or an invalid digit is dialed as pa rat of the area code (i.e., “#” or “*”), the USER program mode is exited (the RED LED is extinguished and relay K1 is de-energized), and the previously stored prefix is retained.

FIGS. 5c and 5S: Long Distance Program Mode

The LONG DISTANCE program mode is entered when the phone is on-hook and the long distance input is detected as active. The device sources the voltage applied to the telephone, and the digits dialed by the telephone do not reach the telephone line.

The LONG DISTANCE prefix is typically programmed during the manufacturing of the device, but can be changed at any time by use of a secure key. This prefix can have a maximum length of 29 digits.

After the LONG DISTANCE program mode is entered, all numbers dialed are read and stored in EEPROM memory as the long distance prefix. The completion of this program mode is signaled by detecting “##.” After the prefix is successfully stored, the GREEN LED is extinguished and R belay K1 is de-energized, which re-connects the telephone to the telephone line. If the telephone is hung up (goes on-hook) prior to receiving “##,” the LONG DISTANCE program mode is exited (the GREEN LED is extinguished and relay K1 is de-energized), and the previously stored prefix is retained. Both the “#” and “*” digits can be used as part of the LONG DISTANCE prefix.

FIG. 5T: Interrupts

A single interrupt, TIMER 0 overflow, is utilized for performing multiple timing functions. The micro controller clock frequency is 3.58 MHz, which equates to an instruction cycle time of 3.352 microseconds. TIMER 0 is an 8 bit register, which is incremented every 3.352 microseconds (1 instruction cycle), and will overflow every (3.352×256)=0.8581 milliseconds. When the timer overflows, the interrupt service routine is executed, which performs the following functions?

Adjusts the Short Timer register, and sets the Short Timer Complete flag when the short timer expires.

Adjusts the Long Timer register, and sets the Long Timer Complete flag when the long timer expires.

Reads and de-bounces the dial tone input (every other interrupt).

Reads and de-bounces the off-hook input (every other interrupt).

The de-bouncing of the dial tone and off-hook inputs is done on alternating interrupts. This allows the de-bounce times to be extended to (2×0.8581)=1.7162 milliseconds (maximum). A single bit flag, X2_FLAG, is used to keep track of when the inputs should be processed.

The short delay of FIG. 5T is based on a general-purpose 8-bit software timer, termed Short Timer, which is decremented every time the interrupt service routine is executed. After each decrement of the Short T timer register (S_DELAY_CNTR), the timer is checked for a terminal value (00). If the register is at its terminal value, the Short Timer Complete flag (ST_DELAY) is set to indicate the completion of the time delay. The Short Timer is used when a time delay less than 219 milliseconds is required.

The long delay of figure ST is based on a general-purpose 16-bit software timer, termed Long Timer, which decrements every time the interrupt service routine is executed. After each decrement of the Long Timer register (L_DELAY_HI, L_DELAY_LOW), it is check for its terminal value (0000). If the register is at its terminal value, the Long Timer Complete flag (LT_DELAY) is set to indicate the completion of the time delay. The Long Timer is used when a time delay less than 56 seconds is required.

The decision step labeled “Dial Tone present” of FIG. 5T is based on a hardware input from the dial tone detection circuitry which s de-bounced to prevent false detection of a dial tone signal. During each execution of the interrupt service routine, the dial tone input is read. A dial tone counter register (DT_CNTR) is used to keep track of how many times the dial tone input was read as either active or inactive. If the input is active, the counter is incremented. If the input is inactive, the counter is decremented but not beyond 0. A single bit flag (DIAL_TONE_DB) is used to indicate the state of the de-bounced input. When the counter has been incremented to a maximum value (DT_MAX), DIAL_TONE_DB is set to indicate an active input. If the counter is 0, DIAL_TONE_DB is cleared to indicate an inactive input.

The decision step labeled “Off hook present” of FIG. 5T is based on a hardware input from the off-hook detection circuitry which is de-bounced to prevent false detection of an off-hook signal. During each execution of the interrupt service routine, the off-hook input is read. An off-hook counter register (OH_CNTR) is used to keep track of how many times the off-hook input was read as either active or inactive. If the input is active, the counter is incremented. If the input is inactive, the counter is decremented (but not beyond 0). A single bit flag (OFF_HOOK_DB) is used to indicate the state of the de-bounced input. When the counter has been incremented to a maximum value (OH_MAX), OFF_HOOK_DB is set to indicate an active input. If the counter is 0, OFF_HOOK_DB is cleared to indicate an inactive input.

The following table identifies the addresses of the various Input and Output devices. Note that some addresses are used as both an input port as well as an output port.

Input/Output Port Assignments

| | Input/ | | |
|---|---|---|---|
| Address | Output | Function | State |
| P1.0 | O | SEIZE, telephone line | Logic 1 seizes telephone |
| | | control | line |
| P1.1 | O | K1 Relay Control | Logic 1 energizes |
| | | | relay & disconnects |
| | | | phone |
| P1.2 | O | 8888 WRITE control | Logic 0 activates WRITE |
| | | | signal |
| P1.3 | O | 8888 REGISTER select | Logic control |
| P1.4-P1.7 | I/O | 8888 data lines D0-D3 | 0 or 1 data |
| P1.7 | I/O | EEPROM serial data line | 0 or 1 data |
| P3.0 | O | EEPROM serial clock | Logic control |
| P3.1 | I/O | Blue LED output | Logic 0 illuminates LED |
| | | Undefined input | |
| P3.2 | I | OFF-HOOK input | Logic 0 indicates tele- |
| | | | phone off-hook |
| P3.3 | I/O | Red LED output USER | Logic 0 illuminates LED |
| | | program switch input | Logic 0 indicates active |
| | | | switch input |
| P3.4 | I/O | Green LED output | Logic 0 illuminates LED |
| | | LONG DISTANCE | Logic 0 indicates active |
| | | program switch input | switch input |
| P3.5 | O | 8888 READ control | Logic 0 activates READ |
| | | | signal |
| P3.7 | I | DIAL TONE input | Logic 1 indicates dial |
| | | | tone present |

The BY-PASS mode is a special sub-mode of normal operation. Under certain circumstances, the user may not want to have the LONG DISTANCE or USER defined prefixes dialed with a particular number. To achieve this, the user would dial “#,” prior to dialing the desired number. Under this condition the BY-PASS mode is entered. The BLUE LED is illuminated and the re-dial algorithm is executed, but the LONG DISTANCE and USER prefixes are skipped. A single bit flag (NO_PREFIX) is used to indicate this condition.

When the unit is configured for the BY-PASS mode, the user is restricted from dialing number that begins with “0” or “1.” This prevents the user from bypassing the LONG DISTANCE prefix stored in EEPROM memory. If the unit is in the BY-PASS mode and the first digit of the number dialed is “0” or “1,” the BY-PASS mode is exited. Under this condition, the telephone number will be re-dialed as if the BY-PASS mode was never entered (i.e. the call will be treated as either a local or long-distance call).

The operation of the ATD is completely transparent to the user where the user may dial all normal telephone numbers. The unit will insert both the defined prefix as well as the LONG DISTANCE prefix for the appropriate type of call. Under certain circumstances, it may be desired to temporarily disable the addition of both the USER and LONG DISTANCE prefixes. To do this, simply dial “#,” before the standard 7 digit telephone number. The device will dial the telephone number without any alteration. After completion of this call, the device will revert back to its normal operation, and all future calls will include the USER and LONG DISTANCE prefixes (unless the by-pass mode is selected again).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for a telephone appliance providing automatic connection of telephone calls comprising:
programming prefix numbers;
receiving a dialed number;
executing the re-dial algorithm;
completing the call; and
shutting down the telephone appliance.

2. A method as claimed in claim 1 where said receiving a dialed number comprises receiving a local call from the user telephone.

3. A method as claimed in claim 2 where said programming prefix numbers comprises a user defined dialing prefix programmed by the user.

4. A method as claimed in claim 3 where said user defined dialing prefix comprises a three digit area code.

5. A method as claimed in claim 3 where said completing the call comprises dialing the user defined dialing prefix appended to said dialed number.

6. A method as claimed in claim 1 where said receiving a dialed number comprises receiving a long distance call from the user telephone.

7. A method as claimed in claim 6 where said prefix numbers comprise a long distance dial around prefix associated with a specific long distance service provider.

8. A method as in claim 7 where said long distance dial around prefix comprises 10-10-321 and 10-10-811.

9. A method as claimed in claim 7 where said long distance prefix number is programmed at the factory.

10. A method as claimed in claim 7 where said completing the call comprises dialing the long distance dialing prefix appended to said dialed number unless the dialed number is a toll free number call.

11. A method as claimed in claim 1 where said executing the re-dial program further comprises determining to pass all digits dialed by the telephone to go directly to the telephone service without modification if:
the first digit dialed is “0” or “*”;
the first three digits are an emergency number, information number or a toll access code; and
the first four digits are an emergency number, information number or toll access number preceded by a “1”.

12. A method as claimed in claim 11 where said emergency number comprises 911 and said information number comprises 411 and 311 and said toll access number comprise 800, 855, 866, 877, 888 and 900.

13. An apparatus for connection between the telephone service and a user telephone to provide automatic connection of telephone calls comprising:
a line interface for connection to the telephone service;
a phone interface for connection to the user telephone;
a relay to control the connection of the telephone to the telephone service;
an off-hook detector to signal when the user telephone is in the off-hook condition;
a line seize circuit to enable the apparatus to seize the telephone line and initiate a call;
a dial tone detector to signal when a dial tone is detected on the telephone line;
a DTMF transceiver to receive or generate the standard DTMF tone pairs;
LED indicators for visual confirmation of apparatus operational mode;
a user program switch and a long distance program switch to initiate user programming of the apparatus;
a micro controller to control the apparatus determined by the program code; and
an EEPROM to be used by the micro controller to permanently store the user defined dialing prefix and the long distance dialing prefix.

14. An apparatus as claimed in claim 13 where said micro controller to control the apparatus further comprises:
controls the relay to connect and disconnect the telephone from the telephone line;
reads the input from the dial tone detector to determine when a dial tone is pre sent on the telephone line;
controls the line seize circuit to seize the telephone line;
transmits digits to the telephone line by writing data to the DTMF transmitter;
reads digits from the telephone via the DTMF receiver;
reads the input from the off-hook detector;
writes data to the EEPROM memory to save the user defined dialing prefix and the long distance dialing prefix;
controls the LED indicators to indicate the apparatus operational mode; and
reads inputs from the user program switch and the long distance program switch.

15. An apparatus as claimed in claim 13 further comprises a power on reset circuit to insure that said relay and said line seize circuit are not activated during the micro controller reset time and a power supply to convert commercial power to about 12 VDC.
